(19) United States
(12) Patent Application Publication
(10) Pub. No.: US 2025/0260850 A1
(43) Pub. Date: Aug. 14, 2025

(54) METHODS AND SYSTEMS FOR MANIFEST GENERATION

(71) Applicant: Comcast Cable Communications, LLC, Philadelphia, PA (US)

(72) Inventors: Yasser SYED, La Crescenta, CA (US); Stuart Harold KURKOWSKI, Colorado Springs, CO (US); Alexander GILADI, Denver, CO (US); Ali C. BEGEN, Konya (TR)

(21) Appl. No.: 19/048,687

(22) Filed: Feb. 7, 2025

Related U.S. Application Data
(60) Provisional application No. 63/551,664, filed on Feb. 9, 2024.

(51) Int. Cl. H04N 21/234; H04N 21/81

(52) U.S. Cl. CPC H04N 21/23424; H04N 21/812

(57) ABSTRACT

Systems and methods are described herein for providing a manifest of a plurality of manifests to a client device. A computing device may receive a stream of content from other components of the content distribution network, such as from a content packager. The content may include ad insertion points for insertion of various advertisements. The computing device may also receive off-band instructions from other components of the content distribution network. The off-band instructions may include a single set of instructions, which may be capable of indicating particular subsets ad types, lengths, and the like, for insertion into the content for generating a plurality of different manifests. The computing device may generate a plurality of manifests based on the content and the off-band instructions. SSAIs of the content distribution system may select one of the plurality of manifests for sending to a requesting client.

### CROSS REFERENCE TO RELATED APPLICATIONS

This application claims priority to U.S. Application No. 63/551,664 titled “Methods and Systems for Manifest Generation” and filed Feb. 9, 2024, which is hereby incorporated by reference in its entirety.

### BACKGROUND

In a cloud or network content providing system, content may be packaged as content segments, with advertisements segments inserted within the content in some cases. Server side ad inserters (SSAIs), which may also be known as manifest manipulators, may receive instructions to generate a manifest for a client and may select ads based on characteristics or parameters associated with the client requesting the manifest. However, as the number of clients continues to increase over time, the burden on the SSAIs to generate client-specific manifests for clients may increase, which may result in streaming delays, and overloading of the content distribution network. Accordingly, there is a need for more efficient techniques for generating manifests in content providing systems.

### SUMMARY

Systems and methods are described herein for providing a manifest of a plurality of manifests to a client device. A computing device may receive a stream of content from other components of the content distribution network, such as from a scheduler. The content may include ad insertion points for insertion of various advertisements, or for replacement of advertisement. The computing device may also receive off-band instructions from other components of the content distribution network. The off-band instructions may include a single set of instructions, which may be capable of indicating particular subsets ad types, lengths, and the like, for insertion into the content for generating a plurality of different manifests. The computing device may generate a plurality of manifests based on the content and the off-band instructions. SSAIs of the content distribution system may select one of the plurality of manifests for sending to a requesting client, for example, the manifests may include a property indicating an intended audience, where the selection may be based on this property. The burden of the SSAIs may be lessened by selecting one of the generated manifests, which may mitigate the possibilities of streaming delays.

### BRIEF DESCRIPTION OF THE DRAWINGS

The following drawings show generally, by way of example, but not by way of limitation, various examples discussed in the present disclosure. In the drawings:

FIG. 1 shows an example system;

FIG. 2 shows an example process;

FIG. 3 shows an example instruction set and manifests;

FIG. 4 shows an example system;

FIG. 5 shows an example system;

FIG. 6 shows an example system;

FIG. 7 shows an example process;

FIG. 8 shows an example process; and

FIG. 9 shows an example computing device.

### DETAILED DESCRIPTION OF ILLUSTRATIVE EMBODIMENTS

Systems and methods are described herein for efficient manifest generation of a content distribution network. A set of instructions may be generated for packaging different versions of a combination of streaming content and advertisements. The set of instructions may be off-band communications, such as Society of Cable Telecommunications Engineers (SCTE 224) communications. The set of instructions may include instructions for generating multiple manifests corresponding to the content and advertisements. For example, each manifest may contain content, or information indicative of content locations, in a different ordering compared to other manifests of the plurality. Likewise, locations, and particular ad segments, may vary across the plurality of manifests.

A computing device of a content delivery system, such as a media presentation description (MPD) creator, may receive the set of instructions, and may generate a plurality of manifests corresponding to the content. The computing device may make the plurality of manifests available to SSAIs of the content distribution network. When a client device requests access to the content, an SSAI may determine parameters associated with the client device, and may select one of the generated plurality of manifests for the client device. The SSAI may then send the selected manifest to the client device. The processing burden on the SSAIs may thus be decreased. Further, the different manifests for a given content may allow for expanding access of the content to clients. For example, in the case where the content is a Free advertising supported streaming television (FAST) channel, the plurality of manifests may allow for different content platforms, clients across different regions, and the like, to access the FAST channel.

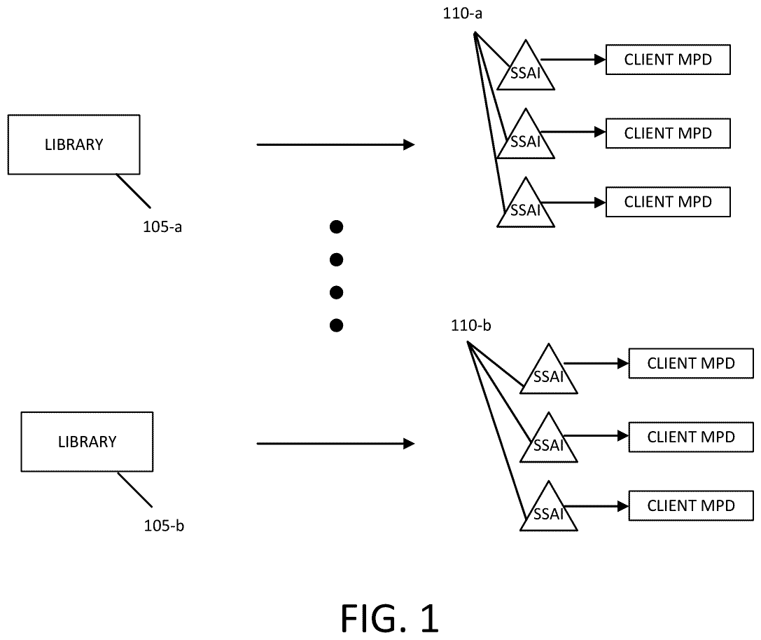

FIG. 1 shows a system 100 for delivering content. The system 100 may include a plurality of content libraries 105. Each of the content libraries may store content, such as video on demand (VOD) content. For example, each content library 105 may store content segments of a FAST channel. In some cases, each content library may store media presentation description (MPD) data corresponding to content, which may include parameters, attributes, storage locations, and the like, for content segments of content.

Each library 105 may be configured to provide the content across a particular delivery platform. For example, library 105-a may be configured to provide the content to devices subscribing to delivery platform A, 105-b may be configured to provide content to devices subscribing to delivery platform B, and so on.

The libraries 105 may generate respective content streams and send the content stream to respective SSAIs 110. For example the library 105-a may generate a first content stream of the content, and send the first content stream to the SSAIs 110-a. Likewise, the library 105-b may generate a second content stream of the content, and may send the second content stream to the SSAIs 110-b.

The SSAIs 110 may generate a manifest for a client requesting access to the content. The SSAIs 110 may receive the respective content stream of the content, and may insert ad segments into received content stream of the content. The respective SSAI 110 may generate a manifest indicative of the stored locations for segments of the content (e.g., content segments and ad segments).

As shown in FIG. 1, the SSAIs 110 maintain a burden for generating manifests of a content based on a client device request for access to the client. As a given manifest is generated specific to the client device, this burden may increase with the number of clients requesting access to the content. Further, a given manifest's generation may also be dependent on the number of delivery platforms configured or subscribed to the content, as the content timing requirements, content order requirements, etc., may be based on preferences or characteristics of a given delivery platform.

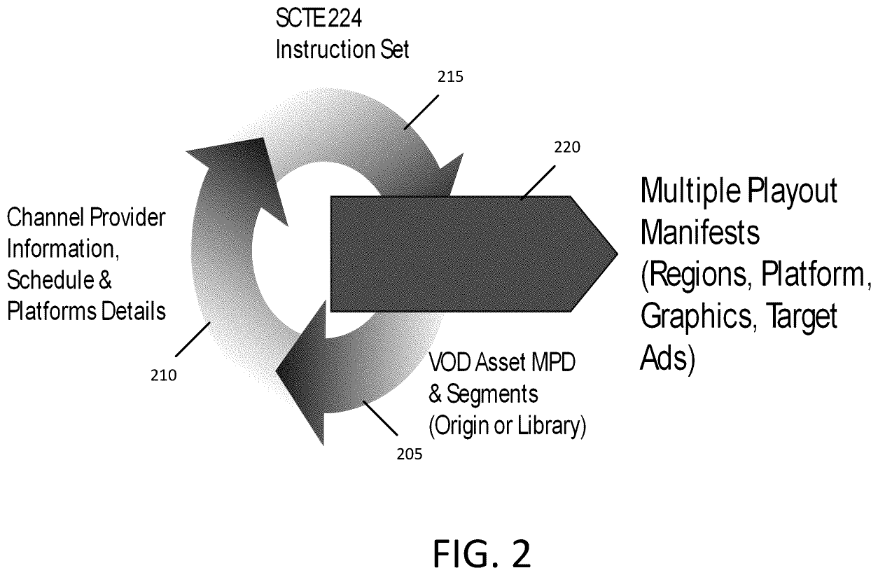

FIG. 2 shows a process flow according to the present disclosure. The disclosure described herein provides for a system, such as a content distribution network system, that may generate a plurality of content manifests from a single source instruction set, out of band instruction set, or both. By implementing this instruction set, the operation complexities (e.g., providing different experiences to specific subgroups of clients) of deploying content across several types of delivery platforms and device may be minimized.

For example, at Step 205, content segments of a content, manifest presentation descriptions (MPDs), or both, may be received by the system. The MPDs may correspond to the content. In some cases, the content segments and MPDs may be received from an origin server (e.g., via a third party) or media library (e.g., ingested content from content owners residing at the distributors) of the system.

At Step 210, information corresponding to characteristics, parameters, and the like, of the content may be received. The characteristic and parameters may be, for example, channel provider information, scheduling information, delivery platform information, and the like.

At Step 215, an off band instruction set may be generated. The off-band instruction set may provide information indicative of a plurality of manifests to be generated. The off-band instruction set may be a Society of Cable Telecommunications Engineers (SCTE) 224, Event Scheduling and Notification Interface (ESNI) instruction set. In some cases, the off-band instruction set may be a single SCTE 224 instruction set or communication.

At Step 220, a plurality of manifests may be generated based on the off-band instruction set. The plurality of manifests may correspond to the content. However, the plurality of manifests may be different from each other with regards to an ordering of content and ad segments, a timing of content and ad segments, a selection of ad segments, graphic overlays, or a combination thereof. For example, the plurality of manifests may be generated for delivery to a client device meeting certain characteristics. For example, the plurality of manifests may be selected for delivery to a client device based on characteristics such as geographic region, delivery platform, graphics requirement, target ad characteristics, and the like.

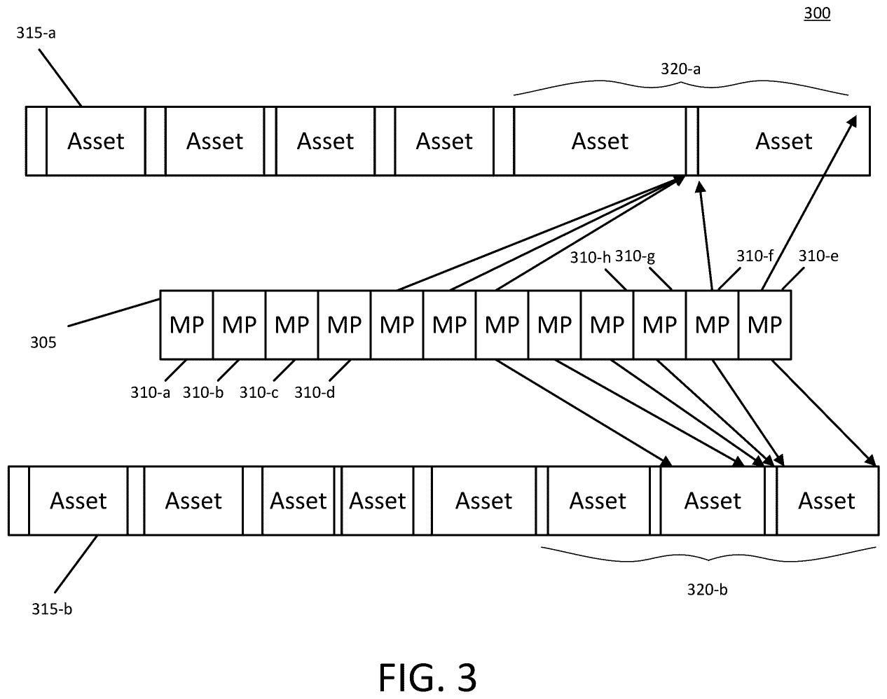

FIG. 3 shows an instruction set and manifests according to the present disclosure. For example, FIG. 3 shows an instruction set 305, which may be an off-band instruction set. The instruction set 305 may also be an SCTE 224 instruction set. The instruction set 305 may include a number of MPDs 310. The MPDs 310 may each correspond to content segments or ad insertion points of the content. For example, MPD 310-a may correspond to a first content segment, MPD 310-b may correspond to a second content segment. Some of the MPDs 310 may correspond to ad insertion points of the content. For example, MPD 310-c may correspond to a first ad insertion point, and MPD 310-d may correspond to a second ad insertion point.

Each MPD 310 may include MPD information corresponding to the respective segment of the content. For example, each MPD 310 can include information such as a start period for the content segment or ad insertion point, distribution information (e.g., via embedding urls), or other MPD information that may be pulled from a video on demand (VOD) asset.

The instruction set 305 may be used to generate a plurality of manifests for the content. For example, a computing device, such as a MPD creator, may receive the instruction set 305 and may generate the first manifest 315-a and the second manifest 315-b based on the instruction set 305. The timing and order of the content assets and ad insert points may be different compared to the first manifest 315-a and the second manifest 315-b. In some cases, these differences may be determined (e.g., from the MPD creator) based on a set of viewing policy factors, which maybe in the form of conditional statements that select different MPD structure paths. For example, the first region of content indicated in the instruction set 305 may include MPDs 310-e through MPD 310-h. MPDs 310-c and 310-f may correspond to a first and second content segment, respectively. MPDs 310-g and 310-h may correspond to first and second ad insert points, respectively. For the first manifest 315-a and based on the instruction set 305, the MPD creator may generate a first region 320-a, where the order of content may include the MPD 310-c, MPD 310-f, and MPD 310-g and 310-h are not included. In comparison, for the second manifest 315-b, the MPD creator may generate a first region 320-b, where the order of content may include the MPD-c, MPD 310-f, MPD-g, and MPD-h.

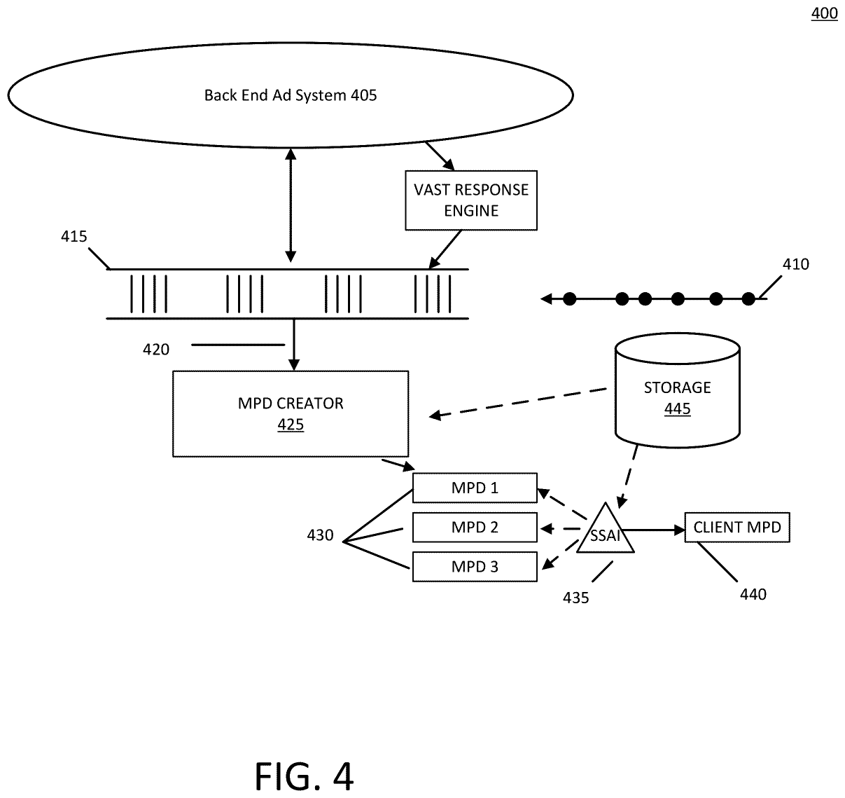

FIG. 4 shows an example system 400 according to the present disclosure. In some cases, the system 400 may be, or may be a part of, a content distribution network system. The system may include a back end ad system 405. In some cases, the back end ad system 405 may provide ad information for a content. For example, the back end ad system 405 may provide a selection of ads for insertion into the content according to various characteristics of a client device requesting the content. For example, the back end ad system 405 may select ad segments for insertion into a content based on geographic region, a client device type, a delivery platform of the client device, and the like.

A schedule of media objects 410 may be received by the system 400. The schedule of media objects 410 may provide content segments of the content, and ad insertion points within the content. In some cases, the schedule of media objects 410 may be received from a scheduler from the content distribution network system.

In some cases, the schedule of media objects 410 may be received by the back end system 405. In some cases the schedule of media objects 410 and the ad segment selections may be received by another computing device in the system 400, such as SCTE 224 service or subsystem 415. Based on the ad segment selections, and the source of media objects 410, an off-band communication 420 may be generated. The off-band communication 420 may include an instruction set as described with reference to FIG. 3. The off-band communication 420 may be an SCTE 224 communication. As the communication is off-band, the instruction set may be packaged, and communicated, separately from the corresponding content. The off-band communication may be sent to the MPD creator 425.

The MPD creator 425 may receive the off-band communication 420 and may generate a plurality of manifests 430 based on the off-band communication 420, such as the manifests 315 discussed with reference to FIG. 3. The plurality of manifests 430 may be distinguished from one another based on a timing of segments of the content, an order of segments of the content, and the like. The plurality of manifests 430 may be generated based on a set of filters corresponding to the instruction set received in the off-band communication. For example, the MPDs of the instruction set may include one or more values, attributes, and the like, which the MPD creator 425 may use to determine a location or incorporation of the corresponding content segment into the manifest. For each manifest to be generated, the MPD creator 425 may have access to one or more filters, such as conditional paths which may inform the MPD creator 425 in selecting and ordering the segments of the content.

The plurality of manifests 430 may be made available to SSAI 435 of the system 400. For example, the plurality of manifests 430 may be sent from the MPD creator 425 to the SSAI 435, or the SSAI 435 may access storage locations of the plurality of manifests 430. The SSAI 435 may receive an indication a client requested the content. The SSAI 435 may receive characteristics or parameters associated with the client device, such as geographic region, delivery platform, device type, and the like. Based on these characteristics, the SSAI 435 may select a manifest from the plurality of manifests 430. The selected manifest 440 may be sent to the client device. In some cases, the SSAI 435 may modify the selected manifest based on additional characteristics corresponding to the client device. For example, the SSAI 435 may replace or insert additional ad segments in the content based on audience factors, such as client demographics (e.g., pulled from storage 445).

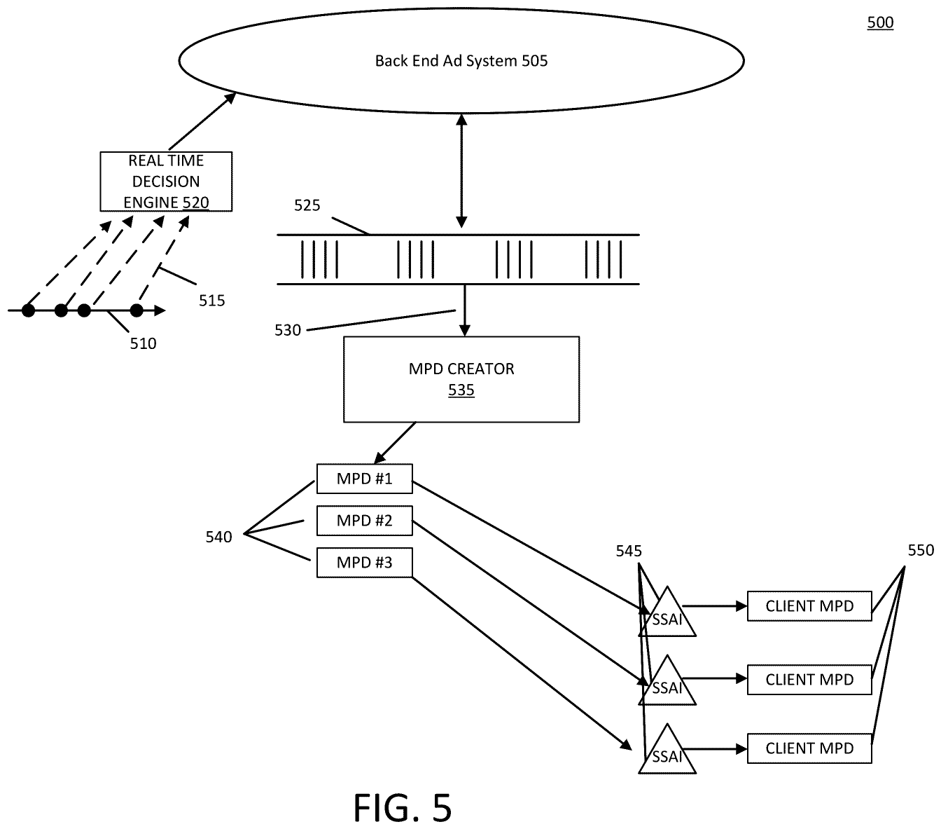

FIG. 5 shows an example system 500 according to the present disclosure. In some cases, the system 500 may be, or may be a part of, a content distribution network system. The system may include a back end ad system 505. In some cases, the back end ad system 505 may provide ad information for a content. For example, the back end ad system 505 may provide a selection of ads for insertion into the content according to various characteristics of a client device requesting the content. For example, the back end ad system 505 may select ad segments for insertion into a content based on geographic region, a client device type, a delivery platform of the client device, and the like.

A schedule of media objects 510 may be received by the system 500. The schedule of media objects 510 may provide content segments of the content, and ad insertion points within the content. In some cases, the schedule of media objects 510 may be received from a scheduler from the content distribution network system. In some cases, the schedule of media objects 510 may be a linear content, such as a FAST channel content. In some cases, the stream of media objects may be a mode 1 stream of media objects, a stream of content, IDs of the content, time slot designated for content, and the like.

In some cases, the schedule of media objects 510 may be received by the back end system 505. In some cases, the schedule of media objects 510 may include a number of ad insertion slots. The location of the ad insertion slots may be communicated to a real-time decision engine 520 via SCTE 258 communications 515. In some cases, the SCTE 258 may be in near real time, such that the break points may be communicated near simultaneously (e.g., as opposed to serially). The real-time decision engine 520 may send information corresponding to the ad insertion slots to the back end ad system 505. The back end ad system 505 may select a number of ads to be inserted into the content based on the ad insertion slot information. The back end ad system 505 may send information corresponding to the ad selections, such as to a SCTE 224 service or subsystem 525.

Based on the ad segment selections, an off-band communication 530 may be generated. The off-band communication 530 may include an instruction set as described with reference to FIG. 3. The off-band communication 530 may be an SCTE 224 communication. As the communication is off-band, the instruction set may be packaged, and communicated, separately from the corresponding content. The off-band communication 530 may be sent to the MPD creator 535.

The MPD creator 535 may receive the off-band communication 530 and may generate a plurality of manifests 540 based on the off-band communication 530, such as the manifests 315 discussed with reference to FIG. 3. In some cases, the MPD creator 535 may also receive MPDs corresponding to the content, which may further assist in generating the plurality of manifests. Alternatively, periods of VOD asset MPDs may be inserted into the instruction set, which may be assembled into a channel layout manifest, which may also include attributes and elements defined from the channel provider information. The plurality of manifests 540 may be distinguished from one another based on a timing of segments of the content, an order of segments of the content, and the like. The plurality of manifests 540 may be generated based on a set of filters corresponding to the instruction set received in the off-band communication. For example, the MPDs of the instruction set may include one or more values, attributes, and the like, which the MPD creator 535 may use to determine a location or incorporation of the corresponding content segment into the manifest. For each manifest to be generated, the MPD creator 535 may have access to one or more filters (e.g., defined in SCTE 224 by viewing policies, applied audiences, etc.) such as conditional paths which may inform the MPD creator 535 in selecting and ordering the segments of the content.

The plurality of manifests 540 may be made available to SSAIs 545 of the system 500. For example, the plurality of manifests 540 may be sent from the MPD creator 535 to the a respective SSAI 545, or the SSAI 545 may access storage locations of the plurality of manifests 540. The SSAI 545 may receive an indication a client requested the content. The SSAI 545 may receive characteristics or parameters associated with the client device, such as geographic region, delivery platform, device type, and the like. Based on these characteristics, the SSAI 545 may select a manifest from the plurality of manifests. The selected manifest 550 may be sent to the client device. In some cases, the SSAI 545 may modify the selected manifest based on additional characteristics corresponding to the client device. For example, the SSAI 545 may replace or insert additional ad segments in the content based on audience factors, such as client demographics.

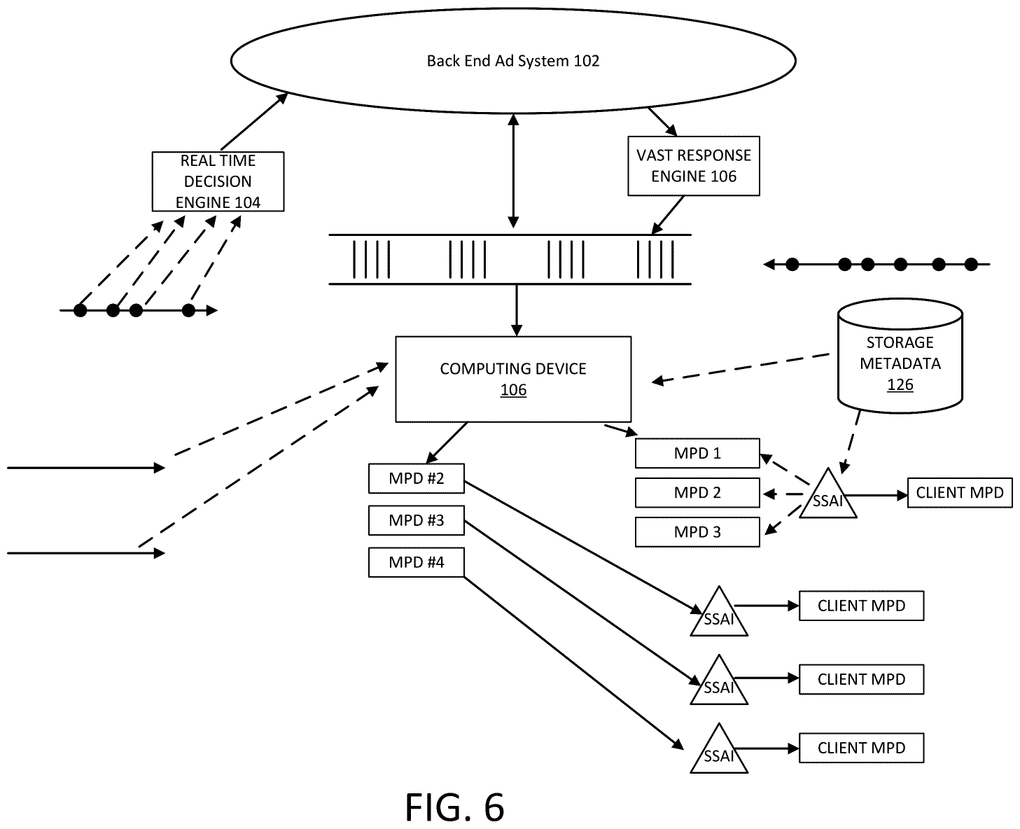

FIG. 6 shows an example system 600 according to the present disclosure. The system 600 may combine the systems of FIGS. 4 and 5. For example, the plurality of manifests may be generated for either mode 1 stream of media objects, mode 2 stream of media objects, or both.

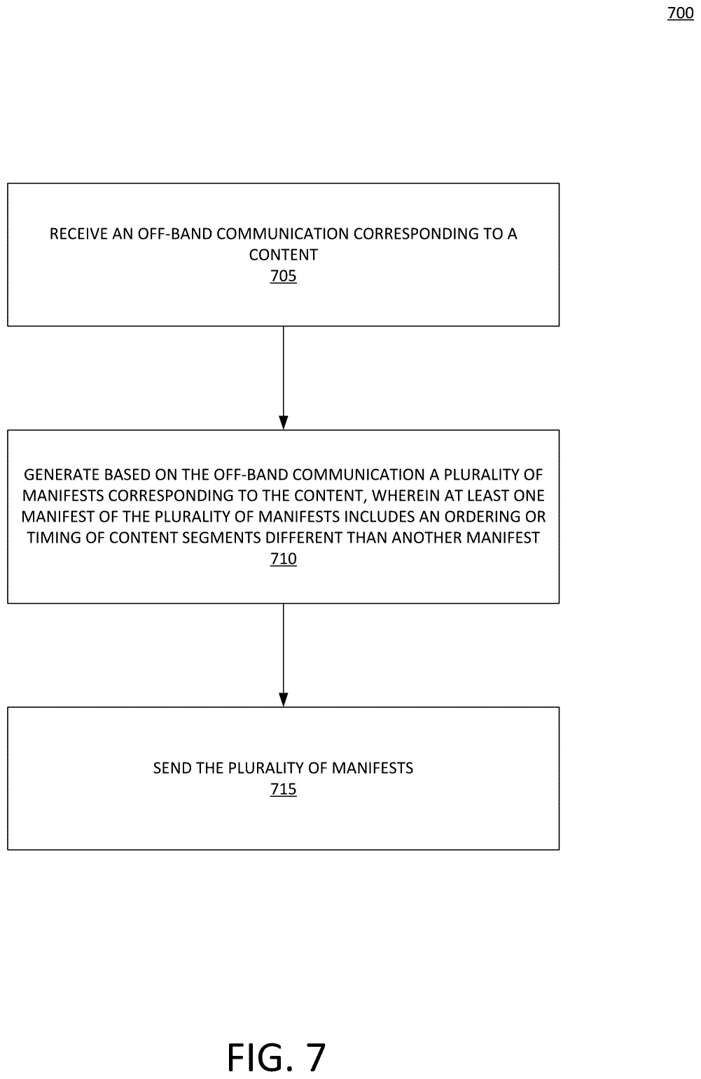

FIG. 7 shows an example method 700. The method may be performed by a system described herein. While each step in the method 700 of FIG. 7 is shown and described separately, multiple steps may be executed in a different order than what is shown, in parallel with each other, or concurrently with each other.

At step 705, an off-band communication corresponding to a content may be received. In some cases, the content comprises a FAST channel. In some cases, the off-band communication comprises a SCTE 224 communication. In some cases, the off-band communication is generated based on channel provider information, scheduling information, content delivery platform information, region information, or a combination thereof.

At step 710, based on the off-band communication, a plurality of manifests may be generated. In some cases, at least one manifest of the plurality of manifests includes an ordering or timing of content segments of the content and advertisement segments compared to other manifests of the plurality of manifests.

At step 715, the plurality of manifests may be sent. The plurality of manifests may be sent to a location accessible by one or more SSAIs of the content distribution network. In some cases, the plurality of manifests are sent to one or server side ad inserters (SSAIs) of the content distribution network.

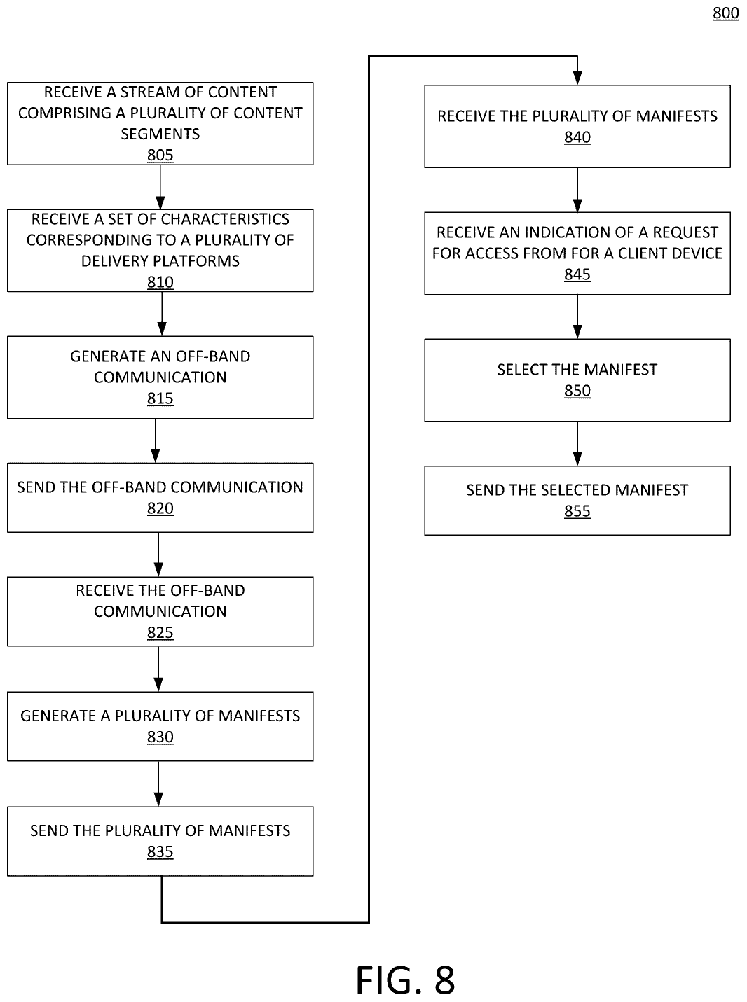

FIG. 8 shows an example method 800. The method may be performed by a system described herein. While each step in the method 800 of FIG. 8 is shown and described separately, multiple steps may be executed in a different order than what is shown, in parallel with each other, or concurrently with each other.

At step 805, a first computing device may receive a stream of content comprising a plurality of content segments.

At step 810, the first computing device may receive a set of characteristics corresponding to a plurality of content delivery platforms capable of supporting the content.

At step 815, an off-band communication service may generate based on the set of characteristics, an off-band communication for generating a plurality of manifests for the content.

At step 820, the off-band communication service may send the off-band communication.

At step 825, a second computing device may receive the off-band communication. At step 830, the second computing device may, based on the off-band communication, generate the plurality of manifests corresponding to the content, wherein at least one manifest of the plurality of manifests includes a different ordering or timing of content segments of the content and advertisement segments compared to other manifests of the plurality of manifests. In some cases, graphic overlays (e.g., station IDs, third downs, and the like) may be different across the manifests. At step 835, the second computing device may send the plurality of manifests.

At step 840, one or more SSAIs may receive the plurality of manifests. At step 845, the one or more SSAIs receive an indication of a request for access to the content by a client device. At step 850, the one or more SSAIs select, based on one or more parameters associated with the client device, a manifest from the plurality of manifests. At step 855, the one or more SSAIs may send the selected manifest to the client device.

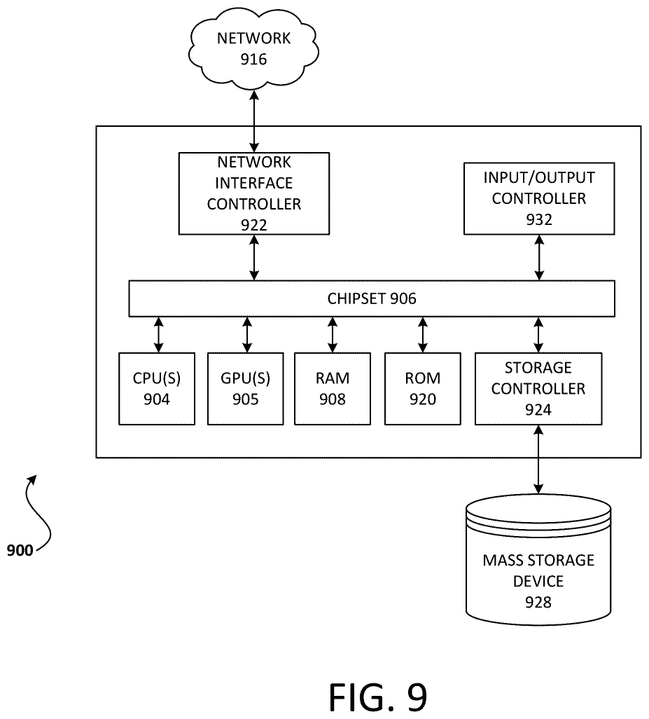

FIG. 9 depicts a computing device 900 that may be used in various aspects, such as the servers, compactors, computing devices, and other devices depicted in FIGS. 4, 5, and 6. The computer architecture shown in FIG. 9 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 7 and 8.

The computing device 900 may include a baseboard, or “motherboard,” which is a printed circuit board to which a multitude of components or devices may be connected by way of a system bus or other electrical communication paths. One or more central processing units (CPUs) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 904 may be augmented with or replaced by other processing units, such as GPU(s) 905. The GPU(s) 905 may comprise processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random access memory (RAM) 908 used as the main memory in the computing device 900. The chipset 906 may further provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 800 in accordance with the aspects described herein.

The computing device 900 may operate in a networked environment using logical connections to remote computing nodes and computer systems through local area network (LAN) 16. The chipset 906 may include functionality for providing network connectivity through a network interface controller (NIC) 922, such as a gigabit Ethernet adapter. A NIC 922 may be capable of connecting the computing device 900 to other computing nodes over a network 916. It should be appreciated that multiple NICs 922 may be present in the computing device 900, connecting the computing device to other types of networks and remote computer systems.

The computing device 900 may be connected to a mass storage device 928 that provides non-volatile storage for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a SATA interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 928 is characterized as primary or secondary storage and the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may further read information from the mass storage device 928 by detecting the physical states or characteristics of one or more particular locations within the physical storage units.

In addition to the mass storage device 928 described herein, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 928 depicted in FIG. 8, may store an operating system utilized to control the operation of the computing device 900. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described herein. The computing device 900 may have access to computer-readable storage media storing computer-executable instructions, which, when executed by the computing device 900, may perform the methods described in relation to FIGS. 7 and 8.

A computing device, such as the computing device 900 depicted in FIG. 9, may also include an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not include all of the components shown in FIG. 9, may include other components that are not explicitly shown in FIG. 9, or may utilize an architecture completely different than that shown in FIG. 9.

As described herein, a computing device may be a physical computing device, such as the computing device 900 of FIG. 9. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
receiving, by a computing device of a content distribution network, an off-band communication corresponding to a content;
generating, by the computing device and based on the off-band communication, a plurality of manifests corresponding to the content, wherein at least one manifest of the plurality of manifests includes an ordering or timing of content segments of the content and advertisement segments different compared to other manifests of the plurality of manifests; and
sending, by the computing device, the plurality of manifests.

2. The method of claim 1, wherein the content comprises a Free advertising-supported streaming television (FAST) channel.

3. The method of claim 1, wherein the plurality of manifests are sent to one or server side ad inserters (SSAIs) of the content distribution network.

4. The method of claim 1, wherein the off-band communication comprises a SCTE 224 communication.

5. The method of claim 1, wherein the off-band communication is generated based on channel provider information, scheduling information, content delivery platform information, region information, or a combination thereof.

6. The method of claim 5, further comprising:
determining, by the computing device and based on the off-band communication, the plurality of manifests to be generated based on the channel provider information, the scheduling information, the content delivery platform information, the region information, or the combination thereof.

7. The method of claim 1, further comprising:
selecting the advertisement segments, for each of the plurality of manifests, based on the off-band communication.

8. The method of claim 7, wherein, the advertisement segments for at least a first manifest of the plurality of manifests are different than the advertisement segments for at least a second manifest of the plurality of manifests.

9. A computing device comprising:
one or more processors;
memory; and
a set of computer-executable instructions stored in the memory that, when executed by the one or more processors; cause:
receiving, by the computing device, an off-band communication corresponding to a content, wherein the computing device is of a content distribution network;
generating, by the computing device and based on the off-band communication, a plurality of manifests corresponding to the content, wherein at least one manifest of the plurality of manifests includes an ordering or timing of content segments of the content and advertisement segments different compared to other manifests of the plurality of manifests; and
sending, by the computing device, the plurality of manifests.

10. The computing device of claim 9, wherein the content comprises a Free advertising-supported streaming television (FAST) channel.

11. The computing device of claim 9, wherein the plurality of manifests are sent to one or server side ad inserters (SSAIs) of the content distribution network.

12. The computing device of claim 9, wherein the off-band communication comprises a SCTE 224 communication.

13. The computing device of claim 9, wherein the off-band communication is generated based on channel provider information, scheduling information, content delivery platform information, region information, or a combination thereof.

14. The computing device of claim 13, wherein the set of computer-executable instructions, when executed by the one or more processors, further cause:
determining, by the computing device and based on the off-band communication, the plurality of manifests to be generated based on the channel provider information, the scheduling information, the content delivery platform information, the region information, or the combination thereof.

15. The computing device of claim 9, wherein the set of computer-executable instructions, when executed by the one or more processors, further cause:
selecting the advertisement segments, for each of the plurality of manifests, based on the off-band communication.

16. A non-transitory computer-readable medium comprising a set of computer-executable instructions that, when executed by one or more processors, cause:
receiving, by a computing device of a content distribution network, an off-band communication corresponding to a content;
generating, by the computing device and based on the off-band communication, a plurality of manifests corresponding to the content, wherein at least one manifest of the plurality of manifests includes an ordering or timing of content segments of the content and advertisement segments different compared to other manifests of the plurality of manifests; and
sending, by the computing device, the plurality of manifests.

17. The non-transitory computer-readable medium of claim 16, wherein the content comprises a Free advertising-supported streaming television (FAST) channel.

18. The non-transitory computer-readable medium of claim 16, wherein the plurality of manifests are sent to one or server side ad inserters (SSAIs) of the content distribution network.

19. The non-transitory computer-readable medium of claim 16, wherein the off-band communication comprises a SCTE 224 communication.

20. The non-transitory computer-readable medium of claim 16, wherein the off-band communication is generated based on channel provider information, scheduling information, content delivery platform information, region information, or a combination thereof.
